(19) United States
(12) Patent Application Publication
(10) Pub. No.: US 2010/0308573 A1
(43) Pub. Date: Dec. 9, 2010

(54) HYDRAULIC ROTATING JOINT WITHOUT GASKET

(76) Inventors: Roberto Iacovella, Roma (IT); Marco Pacchierotti, Roma (IT); Pierluigi Boccalini, Roma (IT); Claudio Agostini, Roma (IT); Domenico Amore, Roma (IT); Luigi Curci, Roma (IT)

Correspondence Address: Hershkovitz & Associates, LLC, 2845 Duke Street, Alexandria, VA, 22314, US

(21) Appl. No.: 12/809,601

(22) PCT Filed: Dec. 19, 2007
(86) PCT No.: PCT/IT2007/000888

§ 371 Date: Aug. 17, 2010

(51) Int. Cl. F16L 27/02

(52) U.S. Cl. 285/120.1

(57) ABSTRACT

The invention relates to a hydraulic rotating joint (100) without gaskets between a fixed part and a movable part of a collector group, comprising a fixed part or stator (1), integral with the fixed part of the collector group, and a movable part or rotor (2), integral with the movable part of the collector group, said stator (1) being provided with an inlet (21) and with an outlet (22) of at least one fluid from and toward a conditioning system provided on said fixed part of the collector group, said rotor (2) being provided qithin a cavity comprised by said stator (1), said rotor being comprised of two rotating arms, submerged within the liquid in said stator (1), said arms respectively comprising the suction tube and discharge tube of liquid to be transferred between the two parts of the collector group, said rotor (2) being provided with means for circulating said liquid between the two parts of the collector group.

The present invention relates to a hydraulic rotating joint without gasket.

More specifically, the invention relates to a rotating joint of the above kind, particularly studied for a collector assembly of an antenna-radar group having the function of transferring electrical supply, signals, RF radiation and cooling liquid of the same antenna to a rotating part.

In the following the specification will be particularly addressed to the application of the rotating joint of a collector assembly of an antenna-radar group, but it is understood that the same can be used in different applications requiring this kind of rottaing joint, independently from the joint dimensions.

As it is well known, tendency to design active radar antennae wherein many power electronic devices are present involved the needing of remoing large amount of heat generated by rotating devices. Furthermore, needing of obtaining high localised exchange coefficients and to uniformare temperature of components has brought to the choice of using liquids as heat vectors. Liquid requires a conditioning apparatus removing heat and maintaining costante inlet temperature of the same liquid. When it is not possible bringing in the rotating part conditioning apparatuses, it exists the problem of transferring and recovering liquid, available “on the ground”, to the rotating part of the antenna groups.

Usually, this function is carried out by the hydraulic joint, that can become part of a more complex assembly destined to the transfer in the rotating part of electrical power and signals (Slip ring) and radiofrequency (RF rotary joint).

Different technological solutions are available on the market, permitting transferring a pressurised fluid into rotating apparatuses.

Choice among the solutions presently available depends on a number of parameters connected with the specific application. Main parameters that particularly influence the choice of sealing are:
kind of fluid;
flow rate of fluid to be transferred to the rotating part;
antenna rotation speed;
dimension geometrical constraints, and particularly joint diameter.

Specifically, kind of fluid determines possibility of maintaining sealing striscianti parts lubricated.

In case water or water-glycole mixture is employed, it must be taken into consideration a low lubrication capability.

Fluid flow rate determines dimensions of passage channels in order to reduce pressure losses at reasonable values for the fluid circulation system.

Antenna rotation speed and dimensions of the joint determine tangential peripheral speed of possible strisciamento sealing members.

On the basis of the direct experience of the Applicant, rotating joints presently available on the market have problems with sealing of gasket between the fixed part and the movable part of the rotating joint coolector group, with the consequent leakage of cooling liquid, reduction of pressure and of flow rate of the same liquid, and thus reduction of cooling system efficiency.

Specifically, reduction of sealing of said gaskets is due by the combination of events, such as:
peripheral speed of movable part;
wear of material comprising said gasket by sfregamento of the same on the movable part of the collector group;
weakening of material comprising said gasket by possible chemical reactions between the same material comprising said gasket and the cooling mixture;
weakening of material comprising said gasket by thermal sbalzi to which it is subkected during its regular use;
standard affaticamento of the gasket material by the continuous operation (24 hours) of the system.

The above sealing problem (leakages and/or perdite) cannot be controlled and, as already mentioned, reduce the efficiency of the rotating joint and can jeopardise optimum operation of the radar system.

These problems are, among the others, at the basis of the search that have brought the Applicant to realise the rotating joint according to the present invention.

In view of the above, the Applicant has realised the rotating joint according to the present invention, permitting solving the above problems and drawbacks, also permitting definitively solving the hydraulic sealing problem for rotating joints, and applicable for every liquid flow rate and foe every rotation speed, thus being particularly competitive for large flow rates and low rotation speeds.

The advantage of the proposed solution is further increased, besides by a clear technical improvement, also by a meaningful reduction of costs and maiteinance.

Another object of the present invention is that of realising a rotating joint without sealing gaskets between the fixed part and the movable part.

It is therefore specific object of the present invention a hydraulic rotating joint without gaskets between a fixed part and a movable part of a collector group, comprising a fixed part or stator, integral with the fixed part of the collector group, and a movable part or rotor, integral with the movable part of the collector group, said stator being provided with an inlet and with an outlet of at least one fluid from and toward a conditioning system provided on said fixed part of the collector group, said rotor being provided qithin a cavity comprised by said stator, said rotor being comprised of two rotating arms, submerged within the liquid in said stator, said arms respectively comprising the suction tube and discharge tube of liquid to be transferred between the two parts of the collector group, said rotor being provided with means for circulating said liquid between the two parts of the collector group.

Particularly, according to the invention, said stator has a toroidal shape with a hemi-circular section, and a horizontal troncamento plane.

Preferably, according to the invention, said liquid inlet and outlet of the stator, are comprised of holes.

Still according to the invention, said holes are in a position radially spaced at least of 90° each other.

According to the invention, stator, conditioning system and inlet and oulet comprise together a primary circuit.

Furthermore, according to the invention, said rotor is placed on two bearings.

Particularly, said rotating arms of the rotor are anchored to a cylindrical body integral with the rotating part of the collector group.

Still according to the invention, said means for circulating the fluid are comprised of a pump.

According to the invention, stator, rotor, circulation means and hydraulic part of the collector group comprise a secondary circuit.

Finally, according to the invention, said reservoir is an atmospheric pressure reservoir.

The present invention will be now described, for illustrative but not limitative purposes, according to its preferred embodiments, with particular reference to the figures of the enclosed drawings, wherein:

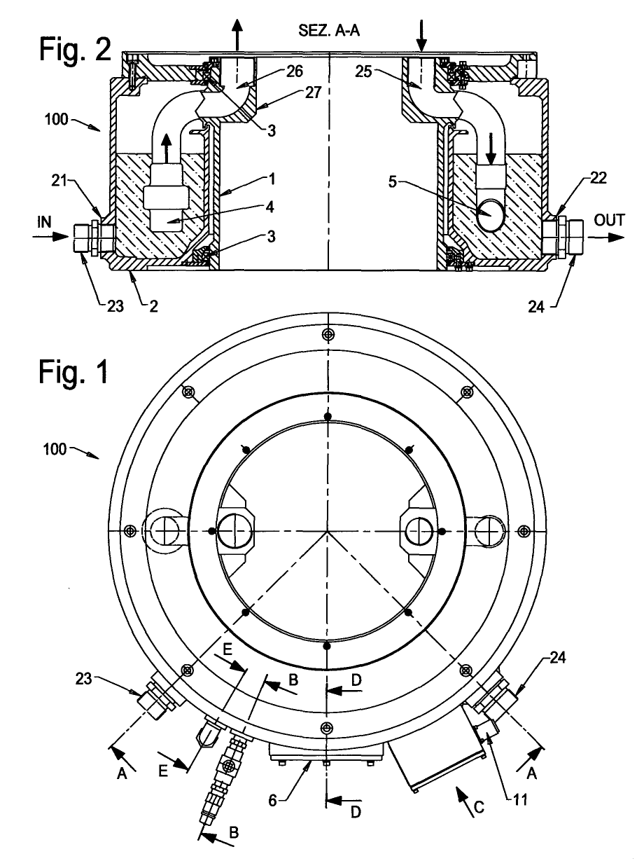

FIG. 1 is a top view of a hydraulic rotatinc joint without gaskets according to the invention;

FIG. 2 is a section view taken along line A-A of FIG. 1;

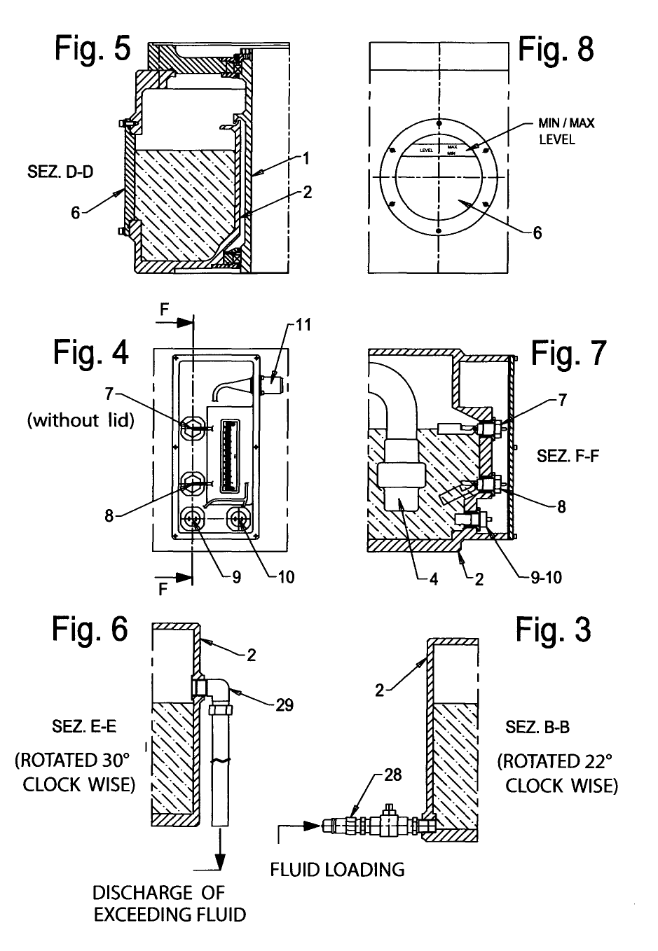

FIG. 3 is a section view taken along line B-B of FIG. 1;

FIG. 4 is a section view taken along line C-C of FIG. 1;

FIG. 5 is a section view taken along line D-D of FIG. 1;

FIG. 6 is a section view taken along line E-E of FIG. 1;

FIG. 7 is a section view taken along line F-F of FIG. 1;

FIG. 8 shows a particular of the rotating joint of FIG. 1; and

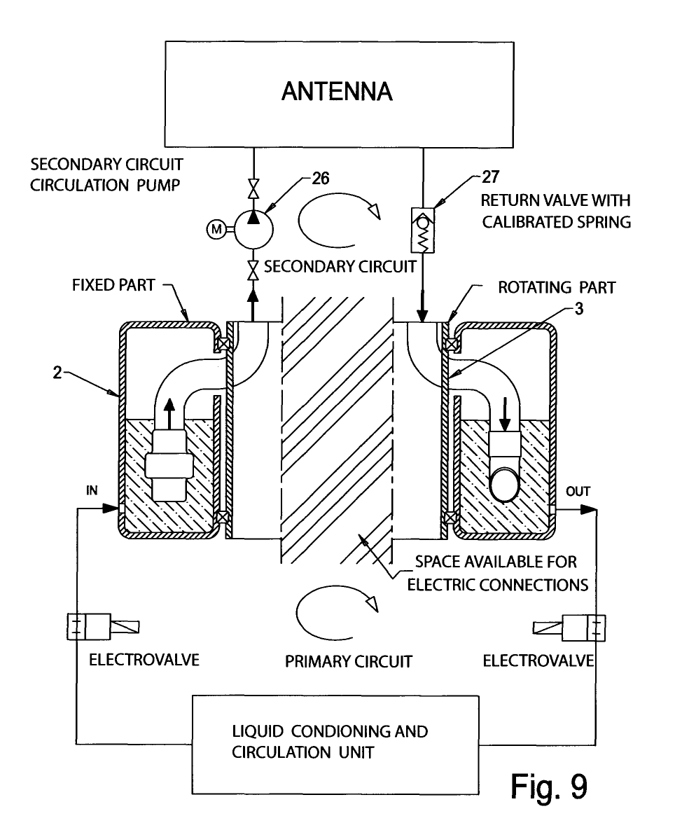

FIG. 9 shows a scheme of a radar-antenna group provided with rotating joint according to the invention.

Observing the figures of the enclosed drawings, it is shown a rotating joint according to the invention, generically indicated by reference number 100, providing a rotor 1, a stator 2, two bearings 3, a check valve 4, a 90° joint 5, an inspection lid 6, a maximum level switch 7, a minimum level switch 8, a thermostatic switch 9 (15° C.), a thermostatic switch 10 (68° C.), and a supply connector 11.

As it can be observed from figures, joint 100 is comprised of two parts, respectively a fixed part 1 (stator) and a movable part 2 (rotor). Stator 1 is integral with the fixed part of the antenna group (not shown but generically indicated by “antenna” block in FIG. 9), while rotor 2 is integral with the rotating part of the antenna group and thus with the same antenna.

Stator 1 is substantially comprised of a hemi-toroidal cylinder, with the troncamento plane perpendicular to the cylinder axis. Stator 1 is provided with two holes 21 and 22, suitably threaded for connection with liquid inlet 23 and outlet 24 tubes from and toward the conditioning system (not shown, but generically indicated by “liquid conditioning and circulation unit” in FIG. 9, provided in the fixed part. Holes 21 and 22 are spaced of at least 90° in a radial direction.

Stator 1, conditioning system and connection tubes 23, 24 comprise the primary circuit, wherein stator 1 can be considered the expansion reservoir.

Toroidal shape of stator 1, rather than simply cylindrical, even if the shape is not determinante for the functionality of the device, and thus not unduly limiting the invention, has the great advantage of leaving a space free in correspondence of the rotation axis for other possible devices, such as the RF Rotary Joint.

Rotor 2 is placed within the cavity comprised of the stator 1, supported by suitable rotation bearings 3. It is comprised of two rotating arms 25 and 26, submerged within stator liquid 1, anchored to a cylindrical body 27m integral with the lower part of the antenna, from which it is driven. Two arms 25, 26 are respectively liquid suction tube and discharge tube for cooling antenna. In order to realise circulation of liquid within antenna, a suitable pump 31 must be installed in the rotating part 2.

The assembly comprised of stator 1, rotor 2, pump 31 and hydraulic part of antenna comprise the secondary circuit. Also in this case stator 1 is circuit expansion reservoir.

When pumps of primary circuit and of secondary circuit are operated, algebric sum of flow rates arriving at joint 100 is always equal to zero, independently from value of flow in primary circuit and secondary circuit, so that liquid level within joint 100 stator 1 is costante.

Joint 100 does not require any specific adjustment for its proper operation.

At the inlet of the suction branch 25 of secondary circuit it is provided a non ritorno valve 30 (FIG. 9) preventing emptying of this branch with pump 31 inactive, so as to avoid disinnesco of the same.

It is suitable installing a non ritorno valve, with pre-loaded spring, also on retunr branch of secondary circuit, in order to ensure impossibility of emptying antenna circuit caused by possible air inclusions.

Statoric reservoir is provided with a visive spia 6, to permit control of liquid level within the same, with a bocchettone 28 for filling it during the first start, and with a discharge cock 29. In case an out of control increase of liquid level within reservoir, it is provided a sfioro channel ensuring guided outflow of excess liquid outward joint 100, so as not to damage anything.

Furthermore, two sensors 7, 8 are provided able to provide high and low level alarm signals, in case of occasional obstructions or losses within circuits that could unbalance flow rate within joint 100, with the consequent anomalous variation of liquid level. As already mentioned, hydraulic rotating joint 100 according to the invention has been realised to transfer and recover refrigerating liquid provided to a conditioning apparatus fixed on the ground to a rotating antenna.

Basic solution is that of separating circulation of refrigerating liquid into two rings: one in stator 1, or primary circuit, and one in rotor 2, or secondary circuit.

Two circuits have a common atmospheric pressure reservoir (pelo libero) which is basic component pf joint 100. each one of the two circuits must be provided with a liquid circulation pump. Both pumps suck liquid from reservoir (joint) and return the same to the reservoir. Primary circuit is directly connected to container comprising the reservoir, while secondary circuit sucks and introduces liquid from/into reservoir by suitably shaped tubes, suspended above the reservoir and connected with the rotating device.

Cool liquid arriving from the conditioning system and warm liquid arriving from antenna are mixed within reservoir, thus reaching an intermediate temperature which is the basis of calculation of the two circuits flow rates. Reservoir, ideally thought as an adiabatic system, is an ideal equicurrent exchanger wherein heat transferred to the secondary circuit by antenna electronic components is integrally transferred to the primary circuit.

Said reservoir is at atmospheric pressure and does not require a hydraulic sealing device.

Contrary to the traditional solutions, fluid circulation is not interrupted occurring within a single circuit, and joint must transfer, besides liquid flow, also pressure necessary for circulating the same liquid within antenna. This latter feature generally implies adoption of strisciamento sealing devices on liquid circulation channels.

Paramenters are three: hydraulic, thermal and mechanical parameters.

Hydraulic parameters are total flow to be send in antenna and pressure necessary for overcoming carico losses in the antenna (or more generally of the device in the rotating part). Thermal paramenters are heat to be removed and liquid inlet temperature. Mechanical parameters are dimension constraint and antenna rotation speed.

The solution according to the present invention was realised just on the basis of an application having the following main parameters:
kind of fluid: water (40%)-etehilnic glicole (60%) mixture;
fluid flow rate: 5000-11000 l/h;
antenna rotation speed: 6-15 rounds/minute;
diameter of the joint in correspondence of the gasket contact surface: 400 mm.

The present invention has been described for illustrative but not limitative purposes, according to its preferred embodiments, but it is to be understood that modifications and/or changes can be introduced by those skilled in the art without departing from the relevant scope as defined in the enclosed claims.

1. Hydraulic rotating joint without gaskets between a fixed part and a movable part of a collector group, characterised in that it comprises a fixed part or stator, integral with the fixed part of the collector group, and a movable part or rotor, integral with the movable part of the collector group, said stator being provided with an inlet and with an outlet of at least one fluid from and toward a conditioning system provided on said fixed part of the collector group, said rotor being provided qithin a cavity comprised by said stator, said rotor being comprised of two rotating arms, submerged within the liquid in said stator, said arms respectively comprising the suction tube and discharge tube of liquid to be transferred between the two parts of the collector group, said rotor being provided with means for circulating said liquid between the two parts of the collector group.

2. Hydraulic joint according to claim 1, characterised in that said stator has a toroidal shape with a hemi-circular section, and a horizontal troncamento plane.

3. Hydraulic joint according to claim 1, wherein said liquid inlet and outlet of the stator, are comprised of holes.

4. Hydraulic joint according to claim 1, wherein said holes are in a position radially spaced at least of 90° each other.

5. Hydraulic joint according to claim 1, wherein stator, conditioning system and inlet and oulet comprise together a primary circuit.

6. Hydraulic joint according to claim 1, wherein said rotor is placed on two bearings.

7. Hydraulic joint according to claim 1, wherein said rotating arms of the rotor are anchored to a cylindrical body integral with the rotating part of the collector group.

8. Hydraulic joint according to claim 1, wherein said means for circulating the fluid are comprised of a pump.

9. Hydraulic joint according to claim 1, wherein stator, rotor, circulation means and hydraulic part of the collector group comprise a secondary circuit.

10. Hydraulic joint according to claim 1, wherein said reservoir is an atmospheric pressure reservoir.
